(19) United States
(12) Patent Application Publication
(10) Pub. No.: US 2018/0167164 A1
(43) Pub. Date: Jun. 14, 2018

(54) Ultra Reliable Low Latency Communications (URLLC) Transmission

(71) Applicant: MEDIATEK INC., Hsinchu (TW)

(72) Inventors: Hsuan-Li Lin, Hsinchu (TW); Pei-Kai Liao, Hsinchu (TW); Wei-De Wu, Hsinchu (TW)

(21) Appl. No.: 15/835,768

(22) Filed: Dec. 8, 2017

Related U.S. Application Data
(60) Provisional application No. 62/432,736, filed on Dec. 12, 2016.

(51) Int. Cl. H04L 1/00; H04W 72/12

(52) U.S. Cl. CPC H04L 1/0042; H04L 1/1812; H04W 72/1205; H04L 1/0038

(57) ABSTRACT

A method for URLLC transmission with UE blind detection on scheduling information is proposed. Since increased control channel reliability requires increased physical resource, it is proposed to exploit UE blind detection on part of the URLLC data burst to trade-off control channel reliability with reduced physical radio resource for URLLC transmission. The URLLC burst is encoded to a plurality of low-density parity-check (LDPC) code blocks (CBs), and UE blindly decodes over multiple candidate configurations of the first data CB, and then the non-signaled scheduling information and the first data CB are successfully retrieved passing CRC check, where the CRC of longer size is added to the first data CB. The proposed method leverages UE blind detection and higher layer signaling to carry part of scheduling information to reduce control channel payload, which saves physical radio resource and improves reliability.

### CROSS REFERENCE TO RELATED APPLICATIONS

This application claims priority under 35 U.S.C. § 119 from U.S. Provisional Application No. 62/432,736 entitled “URLLC Transmission,” filed on Dec. 12, 2016, the subject matter of which is incorporated herein by reference.

### TECHNICAL FIELD

The disclosed embodiments relate generally to Ultra-Reliable Low Latency (URLLC) transmission, and, more particularly, to control channel scheduling for URLLC application in next generation 5G systems.

### BACKGROUND

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs). Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE networks, Physical Downlink Control Channel (PDCCH) is used for downlink (DL) scheduling or uplink (UL) scheduling of Physical Downlink Shared Channel (PDSCH) or Physical Uplink Shared Channel (PUSCH) transmission. Typically, PDCCH can be configured to occupy the first one, two, or three OFDM symbols in a subframe/slot. The DL/UL scheduling information carried by PDCCH is referred to as downlink control information (DCI).

The Next Generation Mobile Network (NGMN) Board, has decided to focus the future NGMN activities on defining the end-to-end (E2E) requirements for 5G. Three main applications in 5G include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Multiplexing of eMBB & URLLC within a carrier is also supported. Specifically, the design requirements for 5G includes maximum cell size requirements and latency requirements. The maximum cell size is urban micro cell with inter-site distance (ISD)=500 meters, i.e. cell radius is 250-300 meters. For eMBB service, the E2E latency requirement is <=10 ms; for URLLC service, the E2E latency requirement is <=1 ms.

URLLC is one of the key features of 5G communication systems. URLLC services are mostly carried by small packets, which could occupy only one or few OFDM symbols in a normal subframe/slot from network perspective. Since URLLC data would promptly come in and override the original data, it needs its own physical control channel within the URLLC burst. However, the physical radio resource for URLLC is limited, and the reliability requirement for URLLC is much higher than eMBB (e.g., 10⁵ BLER). As a result, allocating physical radio resource for scheduling information of URLLC is challenging.

A solution is sought for allocating scheduling information for URLLC.

### SUMMARY

A method for URLLC transmission with UE blind detection on scheduling information is proposed. Since increased control channel reliability requires increased physical resource, it is proposed to exploit UE blind detection on part of the URLLC data burst to trade-off control channel reliability with reduced physical radio resource for URLLC transmission. The URLLC burst is encoded to a plurality of low-density parity-check (LDPC) code blocks (CBs), and UE blindly decodes over multiple candidate configurations of the first data CB, and then the non-signaled scheduling information and the first data CB are successfully retrieved passing CRC check, where the CRC of longer size is added to the first data CB. The proposed method leverages UE blind detection and higher layer signaling to carry part of scheduling information to reduce control channel payload, which saves physical radio resource and improves reliability.

In one embodiment, a user equipment (UE) receives a higher layer signal from a base station to determine configuration information for Ultra-Reliable Low Latency Communications (URLLC) in a mobile communication network. The UE determines a URLLC data occasion of a URLLC data burst from the base station. The URLLC data burst comprises one or more code blocks (CBs). The UE blindly decodes URLLC scheduling information based on the URLLC data occasion, wherein the UE blindly decodes at least a modulation and coding scheme (MCS) and a transport block size (TBS) of the URLLC transmission in a first CB of the URLLC data burst. The UE receives the remaining URLLC data burst based on the decoded MCS and TBS.

In another embodiment, a base station (gNB) transmits a higher layer signal to a user equipment (UE) for providing configuration information for Ultra-Reliable Low Latency Communications (URLLC) in a mobile communication network. The gNB provides a URLLC data occasion of a URLLC data burst by the base station. The URLLC data burst comprises one or more code blocks (CBs). The gNB provides URLLC scheduling information carried in the URLLC data burst. The scheduling information comprises at least a modulation and coding scheme (MCS) and a transport block size (TBS) of the URLLC transmission in a first CB of the URLLC data burst.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network supporting Ultra-Reliable Low Latency Communications (URLLC) transmission with UE blind detection on scheduling information in accordance with one novel aspect.

FIG. 2 illustrates simplified block diagrams of a base station and a user equipment in accordance with embodiments of the present invention.

FIG. 3 illustrates a first embodiment of URLLC transmission with configuration for UE blind detection with physical layer signaling.

FIG. 4 illustrates a second embodiment of URLLC transmission with configuration for UE blind detection without physical layer signaling.

FIG. 5 illustrates a third embodiment of URLLC transmission that is multiplexed with eMBB transmission, wherein the physical layer signaling of URLLC is allocated in eMBB control region.

FIG. 6 illustrates one example of resource block allocation indication for URLLC transmission, where the resource block allocation is indicated by the physical location of the physical layer signaling of URLLC in frequency domain.

FIG. 7 is a flow chart of a method of receiving and decoding scheduling information for URLLC transmission from UE perspective in accordance with one novel aspect.

FIG. 8 is a flow chart of a method of encoding and transmitting scheduling information for URLLC transmission from eNB perspective in accordance with one novel aspect.

### DETAILED DESCRIPTION

Reference will now be made in detail to some embodiments of the invention, examples of which are illustrated in the accompanying drawings.

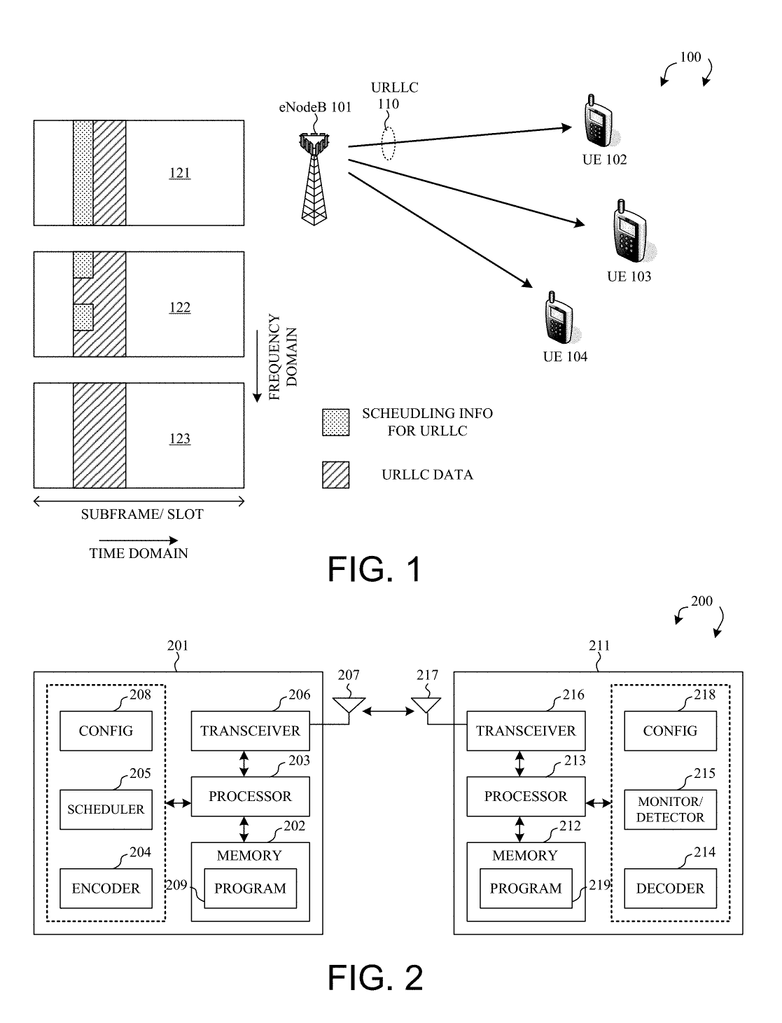

FIG. 1 illustrates a mobile communication network 100 supporting Ultra-Reliable Low Latency Communications (URLLC) transmission with UE blind detection on scheduling information in accordance with one novel aspect. Mobile communication network 100 is an 3GPP LTE OFDM/OFDMA system comprising a base station eNodeB 101 and a plurality of user equipment UE 102, UE 103, and UE 104. In 3GPP LTE system based on OFDMA downlink, the radio resource is partitioned into subframes or slots, each of which is comprised of seven or fourteen OFDMA symbols along time domain. Each OFDMA symbol further consists of a number of OFDMA subcarriers along frequency domain depending on the system bandwidth. When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical uplink shared channel (PUSCH) consisting of a set of uplink radio resources. In LTE, the UE gets the downlink or uplink scheduling information from a physical downlink control channel (PDCCH) that is targeted specifically to that UE. The downlink or uplink scheduling information, carried by PDCCH via physical layer L1 signaling, is referred to as downlink control information (DCI).

URLLC is one of the key features of 5G communication systems. URLLC services are mostly carried by small packets, which could occupy only one or few OFDM symbols in a normal subframe/slot from network perspective. Since URLLC data would promptly come in and override the original data, it needs its own physical control channel within the URLLC burst. However, the physical radio resource for URLLC is limited, and the reliability requirement for URLLC is much higher than eMBB (e.g., 10⁵ BLER). As a result, allocating physical radio resource for scheduling information of URLLC is challenging.

There are possible options for allocating scheduling information for URLLC burst 110 to UE 102. In a first option, URLLC burst is transmitted with full scheduling information via L1 signaling. In one example, as depicted by slot 121, the control channel for explicit dynamic scheduling information is TDMed with data. In another example, as depicted by slot 122, the control channel for explicit dynamic scheduling information is TDMed/FDMed with data. In a second option, as depicted by slot 123, URLLC burst is transmitted with partial scheduling information via signaling. Part of scheduling information for URLLC transmission can be signaled by higher layer, physical layer, or hybrid signaling. UE 102 decides candidate configurations according to the signaled scheduling information. UE 102 blindly detect non-signaled scheduling information for URLLC transmission among the candidate configurations and decode data.

In accordance with one novel aspect, since increased control channel reliability requires increased physical resource, it is proposed to exploit UE blind detection on part of the URLLC data burst to trade-off control channel reliability with reduced physical radio resource for URLLC transmission. The proposed method leverages UE blind detection and higher layer signaling to carry part of scheduling information to reduce PDCCH payload, e.g., L1 signaling, which saves physical radio resource and improves reliability.

In the downlink, the URLLC burst is encoded to a plurality of low-density parity-check (LDPC) code blocks (CBs), and UE blindly decodes over multiple candidate configurations of the first data CB, and then the non-signaled scheduling information and the first data CB are successfully retrieved passing CRC check, where the CRC of longer size is added to the first data CB. In one example, the non-signaled scheduling information comprises modulation and coding scheme and transport block size (MCS/TBS) and indication of resource allocation.

Configuration subset restriction can be provided by higher layer signaling to indicated the candidate configurations for blind detection. Furthermore, sequence based design for data occasion detection and hybrid automatic repeat request (HARQ) handling can be applied. If the first data CB decoding fails, UE may stop decoding the remaining data CBs. Otherwise, UE decode the remaining CBs of the URLLC burst accordingly.

FIG. 2 illustrates simplified block diagrams of a base station 201 and a user equipment 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similar configuration exists in UE 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

The base station 201 and UE 211 also include several functional modules and circuits to carry out some embodiments of the present invention. The different functional modules and circuits can be implemented by software, firmware, hardware, or any combination thereof. The function modules and circuits, when executed by the processors 203 and 213 (e.g., via executing program codes 209 and 219), for example, allow base station 201 to encode and transmit higher layer and physical layer scheduling information to UE 211, and allow UE 211 to receive and decode the scheduling information accordingly. Each of the functional module or circuit may comprise a processor with corresponding program codes.

In one example, eNB 201 comprises a scheduling module 205 that provides downlink scheduling and uplink grant for URLLC transmission, a configurator 208 that provides higher layer signaling for URLLC configurations, and an encoder 204 for encoding the scheduling and configuration information and URLLC data to be transmitted to UE. Similarly, UE 211 comprises a decoder 214 that decodes the content of the high layer signaling, physical layer signaling, and URLLC data, a detection circuit 215 that monitors and detects signaling information via blind detection, and a configuration circuit 218 for obtaining URLLC configurations and URLLC transmission parameters. For blind detection, latency could be one concern. However, since LDPC decoder has large parallelism, the decoding latency is small regarding the blind decoding on first CB. Besides, UE blind detection on LDPC data is feasible when the data size is small, due to LDPC's property of its inherent parity check, which benefits for early termination and mitigating latency comparing to conventional blind detection.

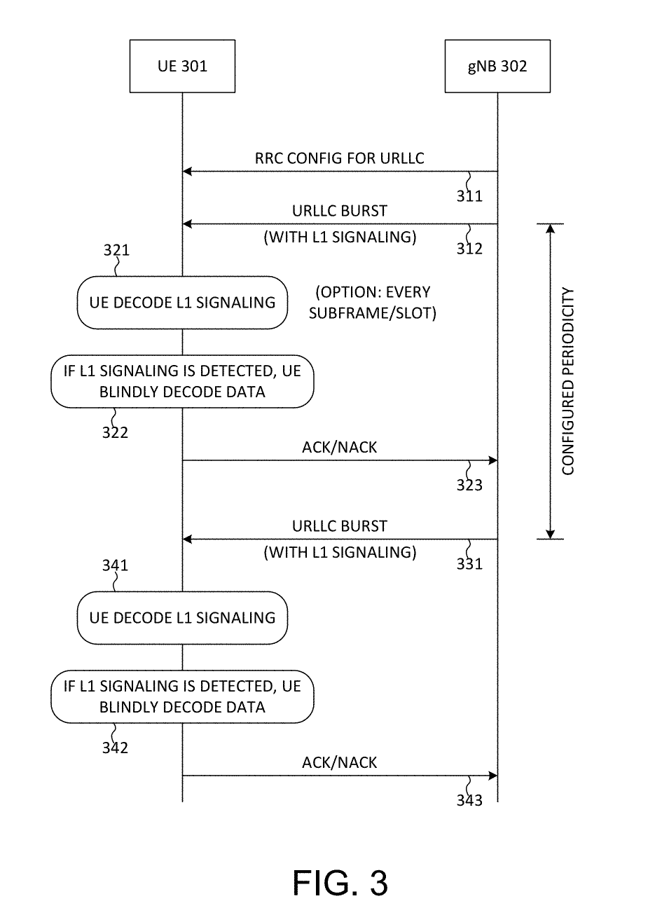

FIG. 3 illustrates a first embodiment of URLLC transmission with configuration for UE blind detection with physical layer signaling. The MSC configuration for URLLC transmission for UE blind detection includes: config#1 is QPSK with code rate of ½; config#2 is QPSK with code rate of ⅓; config#3 is 16QAM with code rate of ⅔. In step 311, gNB 302 transmits an RRC configuration for URLLC to UE 301. For example, the RRC signaling provides MCS config subset restriction, e.g. candidate config={config#1, config#2}. In step 312, gNB 302 sends a URLLC burst with L1 signaling to UE 301. For example, the L1 signaling indicates the URLLC data occasion, HARQ handling info, radio resource block allocation, and subcarrier spacing info. In step 321, UE 301 monitors and detects L1 signaling. For example, UE 301 detects L1 signaling every mini-slot. In step 322, if L1 signaling is detected, UE 301 first determines URLLC data occasion accordingly. UE 301 then blindly detects URLLC transmission among the candidate configurations, regarding the L1 signaling and the configuration subset restriction, in the first URLLC data CB. In step 323, UE 301 confirms whether the URLLC data is decoded successfully by sending an ACK/NACK to gNB 302. If UE 301 does not decode data successfully, gNB 302 could send retransmission. UE 301 monitors the following slots/min-slots/subframes for URLLC retransmission and combines the retransmission with the first transmission. Subsequent URLLC transmission is then repeated from steps 331 through 343.

The L1 physical layer signaling can be further reduced. In another example of FIG. 3, the RRC signaling in step 311 may carry more information, while the L1 signaling in step 312 may carry less information. For example, the RRC signaling carries radio resource block allocation, subcarrier spacing info, and provides MCS config subset restriction, e.g. candidate config={config#1, config#2}. The L1 signaling only indicates the URLLC data occasion and provides HARQ handling info. In yet another example of FIG. 3, instead of monitoring L1 signaling every mini-slot, in step 321, UE 301 monitors and detects L1 signaling based on an RRC-configured URLLC L1 signaling periodicity.

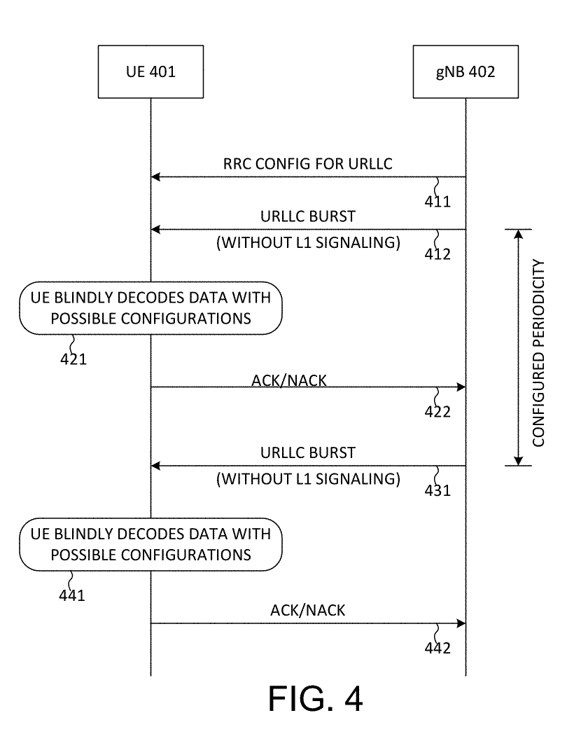

FIG. 4 illustrates a second embodiment of URLLC transmission with configuration for UE blind detection without physical layer signaling. The MSC configuration for URLLC transmission for UE blind detection includes: config#1 is QPSK with code rate of ½; config#2 is QPSK with code rate of ⅓; config#3 is 16QAM with code rate of ⅔. In step 411, gNB 402 transmits an RRC configuration for URLLC to UE 401. For example, the RRC signaling carries a radio resource block allocation indication, subcarrier spacing information, HARQ handling information, and provides MCS config subset restriction, e.g. candidate config={config#1, config#2}. In step 412, gNB 402 sends a URLLC burst without L1 signaling to UE 401. In step 421, UE 401 first determines URLLC data occasion via blind detection. UE 401 then blindly detects URLLC transmission among the candidate configurations, regarding the configuration subset restriction, in the first URLLC CB. In step 422, UE 401 confirms whether the URLLC data is decoded successfully by sending an ACK/NACK to gNB 402. If UE 401 does not decode data successfully, gNB 402 could send retransmission. UE 401 monitors the following slots/min-slots/subframes for URLLC retransmission and combines the retransmission with the first transmission. Subsequent URLLC transmission is then repeated from steps 431 through 442.

The RRC signaling can be further reduced by predefining URLLC transmission parameters. In another example of FIG. 4, the configuration for URLLC for UE blind detection includes: config#1 is QPSK with code rate of ½, resource allocation type 1, 15 subcarrier spacing; config#2 is QPSK with code rate of ⅓, resource allocation type 1, 15 subcarrier spacing; config#3 is 16QAM with code rate of ⅔, resource allocation type 2, 60 subcarrier spacing. The RRC signaling in step 411 carries only HARQ handling info and configuration subset restriction, e.g. candidate config={config#1, config#2}. In yet another example of FIG. 4, instead of blindly detecting URLLC data occasion, in step 321, UE 401 detects URLLC data burst in steps 412 and 431 based on an RRC-configured URLLC data occasion periodicity.

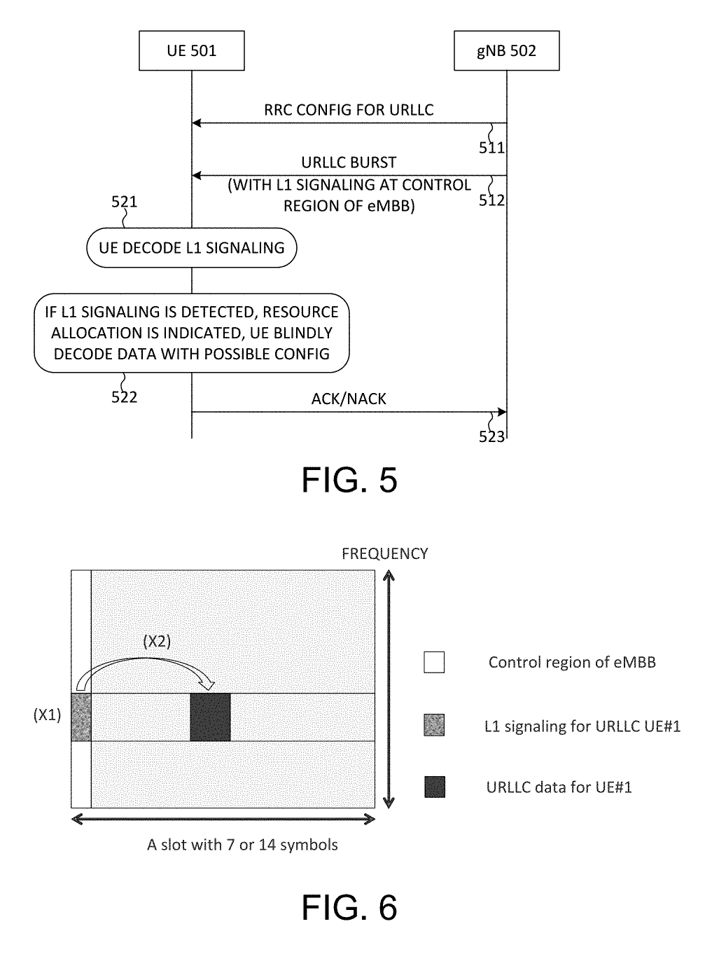

FIG. 5 illustrates a third embodiment of URLLC transmission that is multiplexed with eMBB transmission, wherein the physical layer signaling of URLLC is allocated in eMBB control region. In step 511, UE 501 receives RRC signaling from eNB 502 for URLLC. The RRC signaling may include configuration subset restriction, e.g., candidate config={config#1, config#2}. In step 512, UE 501 receives an URLLC burst from eNB 502 with L1 signaling at control region of eMBB. The L1 signaling may indicate the URLLC data occasion, HARQ handling info, and subcarrier spacing info. In step 521, UE 501 monitors and detects L1 signaling at control region of eMBB every mini-slot. In step 522, if L1 signaling is detected, UE 501 first determines URLLC data occasion accordingly. UE 501 then blindly detects URLLC transmission among the candidate configurations, regarding the L1 signaling and the configuration subset restriction, in the first URLLC data CB. The resource block allocation is indicated by the physical location of the L1 signaling. In step 523, UE 501 confirms whether the URLLC data is decoded successfully by sending an ACK/NACK to gNB 502. If UE 501 does not decode data successfully, gNB 502 could send retransmission. UE 501 monitors the following slots/min-slots/subframes for URLLC retransmission and combines the retransmission with the first transmission.

FIG. 6 illustrates one example of resource block allocation indication for URLLC transmission, where the resource block allocation is indicated by the physical location of the physical layer signaling of URLLC in frequency domain. FIG. 6 depicts a slot/subframe having 7 or 14 OFDM symbols. Typically, for eMBB transmission, the control region for eMBB is allocated in the first OFDM symbol of each slot/subframe. For URLLC transmission, its own physical control channel is located within the URLLC data burst. When URLLC transmission is multiplexed with eMBB transmission, the control region for eMBB can be used for URLLC transmission as well. As depicted in FIG. 6, UE#1 monitors and detects the L1 signaling (X1) for URLLC at the control region of eMBB. Based on the physical location of X1, UE#1 can determine the resource block allocation for URLLC data (X2).

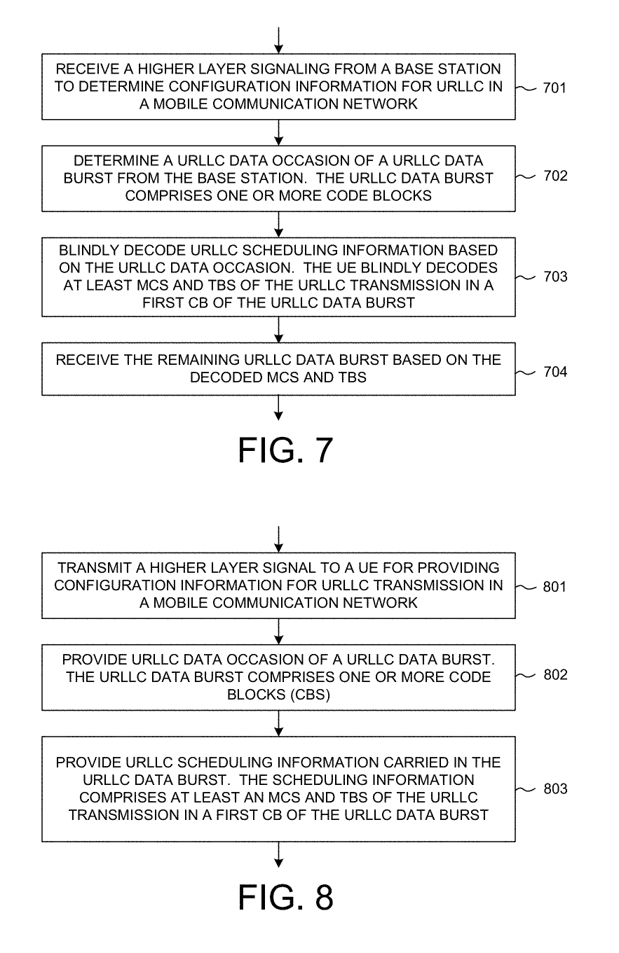

FIG. 7 is a flow chart of a method of receiving and decoding scheduling information for URLLC transmission from UE perspective in accordance with one novel aspect. In step 701, a user equipment (UE) receives a higher layer signal from a base station to determine configuration information for Ultra-Reliable Low Latency Communications (URLLC) in a mobile communication network. In step 702, the UE determines a URLLC data occasion of a URLLC data burst from the base station. The URLLC data burst comprises one or more code blocks (CBs). In step 703, the UE blindly decodes URLLC scheduling information based on the URLLC data occasion, wherein the UE blindly decodes at least a modulation and coding scheme (MCS) and a transport block size (TBS) of the URLLC transmission in a first CB of the URLLC data burst. Finally, in step 704, the UE receives the remaining URLLC data burst based on the decoded MCS and TBS.

FIG. 8 is a flow chart of a method of encoding and transmitting scheduling information for URLLC transmission from eNB perspective in accordance with one novel aspect. In step 801, a base station (gNB) transmits a higher layer signal to a user equipment (UE) for providing configuration information for Ultra-Reliable Low Latency Communications (URLLC) in a mobile communication network. In step 802, the gNB provides a URLLC data occasion of a URLLC data burst by the base station. The URLLC data burst comprises one or more code blocks (CBs). In step 803, the gNB provides URLLC scheduling information carried in the URLLC data burst. The scheduling information comprises at least a modulation and coding scheme (MCS) and a transport block size (TBS) of the URLLC transmission in a first CB of the URLLC data burst.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a higher layer signal from a base station by a user equipment (UE) to determine configuration information for Ultra-Reliable Low Latency Communications (URLLC) transmission in a mobile communication network;
determining a URLLC data occasion of a URLLC data burst from the base station, wherein the URLLC data burst comprises one or more code blocks (CBs);
blindly decoding URLLC scheduling information based on the URLLC data occasion, wherein the UE blindly decodes at least a modulation and coding scheme (MCS) and a transport block size (TBS) of the URLLC transmission in a first CB of the URLLC data burst; and
receiving the remaining URLLC data burst based on the decoded MCS and TBS.

2. The method of claim 1, wherein the configuration information comprises a restricted subset of MCS and TBS values for URLLC transmission.

3. The method of claim 2, wherein the UE further blindly decodes a resource block allocation indication and a subcarrier spacing for URLLC transmission.

4. The method of claim 1, wherein the URLLC data occasion is determined from a physical layer signal for URLLC or from the higher layer signal.

5. The method of claim 4, wherein the physical layer signal is sequence-based to indicate the URLLC data occasion and/or Hybrid automatic repeat request (HARQ) handling information.

6. The method of claim 4, wherein the physical layer signal is allocated in a control region allocated for enhanced Mobile Broadband (eMBB).

7. The method of claim 6, wherein a resource block allocation for the URLLC data burst is indicated by a frequency location of the physical layer signal.

8. The method of claim 1, wherein the first CB of the URLLC data burst has a first cyclic redundancy check (CRC) field, wherein a second CB of the URLLC data burst has a second CRC field, and wherein the first CRC length is longer than the second CRC length.

9. A user equipment (UE) comprising:
a radio frequency (RF) receiver that receives a higher layer signal from a base station to determine configuration information for Ultra-Reliable Low Latency Communications (URLLC) transmission in a mobile communication network;
a configuration circuit that determines a URLLC data occasion of a URLLC data burst from the base station, wherein the URLLC data burst comprises one or more code blocks (CBs); and
a decoder that blindly decodes URLLC scheduling information based on the URLLC data occasion, wherein the UE blindly decodes at least a modulation and coding scheme (MCS) and a transport block size (TBS) of the URLLC transmission in a first CB of the URLLC data burst and wherein the UE receives the remaining URLLC data burst based on the decoded MCS and TBS.

10. The UE of claim 9, wherein the configuration information comprises a restricted subset of MCS and TBS values for URLLC transmission.

11. The UE of claim 10, wherein the UE further decodes a resource block allocation indication and a subcarrier spacing for URLLC transmission.

12. The UE of claim 9, wherein the URLLC data occasion is determined from a physical layer signal for URLLC or from the higher layer signal.

13. The UE of claim 12, wherein the physical layer signal is sequence-based to indicate the URLLC data occasion and/or Hybrid automatic repeat request (HARQ) handling information.

14. The UE of claim 12, wherein the physical layer signal is allocated in a control region allocated for enhanced Mobile Broadband (eMBB).

15. The UE of claim 14, wherein a resource block allocation for the URLLC data burst is indicated by a frequency location of the physical layer signal.

16. The UE of claim 9, wherein the first CB of the URLLC data burst has a first cyclic redundancy check (CRC) field, wherein a second CB of the URLLC data burst has a second CRC field, and wherein the first CRC length is longer than the second CRC length.

17. A method comprising:
transmitting a higher layer signal from a base station to a user equipment (UE) for providing configuration information for Ultra-Reliable Low Latency Communications (URLLC) transmission in a mobile communication network;
providing a URLLC data occasion of a URLLC data burst by the base station, wherein the URLLC data burst comprises one or more code blocks (CBs); and
providing URLLC scheduling information carried in the URLLC data burst, wherein the scheduling information comprises at least a modulation and coding scheme (MCS) and a transport block size (TBS) of the URLLC transmission in a first CB of the URLLC data burst.

18. The method of claim 17, wherein the configuration information comprises a restricted subset of MCS and TBS values for URLLC transmission.

19. The method of claim 2, wherein the configuration information further comprises a restricted subset of resource block allocation indication and a subcarrier spacing for URLLC transmission.

20. The method of claim 1, wherein the base station transmits a physical layer signal for URLLC that is allocated in a control region allocated for enhanced Mobile Broadband (eMBB).

21. The method of claim 20, wherein a resource block allocation for the URLLC data burst is indicated by a frequency location of the physical layer signal.

22. The method of claim 17, wherein the first CB of the URLLC data burst has a first cyclic redundancy check (CRC) field, wherein a second CB of the URLLC data burst has a second CRC field, and wherein the first CRC length is longer than the second CRC length.
